(19) United States
(12) Patent Application Publication
(10) Pub. No.: US 2005/0218808 A1
(43) Pub. Date: Oct. 6, 2005

(54) CCFL tube device

(75) Inventor: Huan Hsiang Hsu, Hsin Chu Hsien (TW)

Correspondence Address: TROXELL LAW OFFICE PLLC;SUITE 1404, 5205 LEESBURG PIKE, FALLS CHURCH, VA, 22041, US

(73) Assignee: TAIWAN FLUORESCENT LAMP CO., LTD.

(21) Appl. No.: 10/813,019

(22) Filed: Mar. 31, 2004

(51) Int. Cl. H01J 5/48; H01J 5/50

(52) U.S. Cl. 313/624; 313/318.01

(57) ABSTRACT

A CCFL tube device has a tube made of transparent materials, a CCFL disposed in the tube and having a lamp exposed out of two ends thereof, a cap covering each ends of the tube, and two terminals symmetrically arranged in the cap for electrically connecting the lamp. The cap is glued to the tube for firm connection. The terminals penetrate through and secure to the cap, each terminal is a hollow pipe and the lamp is exposed by the CCFL to accommodate each of the terminals. Each terminal each is soldered to the lamp following cutting tips of the terminals for electrical connection between the lamp and each of the terminals.

### BACKGROUND OF THE INVENTION

1. Field of the Invention

The present invention relates to a CCFL tube device, and particularly relates to a CCFL tube device adopted for a CCFL and taking advantages of power consumption saving, long life, and easy exchange, where the CCFL is capable of replacing a fluorescent lamp.

2. Background of the Invention

CCFLs, or “Cold Cathode Fluorescent Lamps”, are a kind of low-pressure mercury discharge lamp. The principle of the CCFLs is the same as that of a common fluorescent lamp, in which a trace of mercury is provided inside an envelope having a layer of phosphors coated therein. By adding a high electric field between electrodes at both ends of the envelope, discharge occurs in the low-pressure mercury vapor. Mercury atoms excited by its discharged electrons emit ultraviolet rays of 253.7 Nm, and these ultraviolet- rays excite the phosphors in the envelope. Thus, the CCFLs can be described as a transducer converting electrical energy into light energy. Furthermore, cold means that the electrodes of CCFLs are not heated like in standard neon lamps. The electrodes thereof can be miniaturized and simplified to provide a thin envelope, high illumination, high efficiency, low heat, long life, and stability. For adoption to backlight modules of an LCD, the CCFLs have diameters less than 2.0 mm. The CCFLs having diameter more than 2.6 mm are applicable in scanners, facsimile machines, digital cameras, car inside instruments, super thin ovens, indication lights, bar code machines, declaration lamps, or lighting devices.

Referring to FIG. 1, a conventional CCFL conjunction structure discloses a CCFL 90 having a lamp 91 disposed therein, and a high voltage conductive cable 92 connecting the lamp 91 for a power supply. The lamp 91 is soldered to the high voltage conductive cable 92 for connection; however, there are some problems of soldering and alignment, and the application thereof will be restricted thereby.

Hence, an improvement over the prior art is required to overcome the disadvantages thereof.

### SUMMARY OF INVENTION

The primary object of the invention is therefore to specify a CCFL tube device with reduced power consumption, long life, easy exchange, high production qualities, and high manufacturing efficiency, and avoid the difficulties of orientations thereof and soldering problems, where the CCFL is capable of replacing a fluorescent lamp.

According to the invention, these objects are achieved by a CCFL tube device including a tube made of transparent materials, a CCFL disposed in the tube and having a lamp exposed out of two ends thereof, a cap covering each end of the tube, and two terminals symmetrically arranged in the cap for electrically connecting the lamp.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a cross-sectional profile of a conventional CCFL conjunction structure;

FIG. 2 is a decomposition view of a CCFL tube device according to the present invention;

FIG. 3 is a perspective view of the CCFL tube device according to the present invention; and

FIG. 4 is a cross-sectional profile of the CCFL tube device according to the present invention.

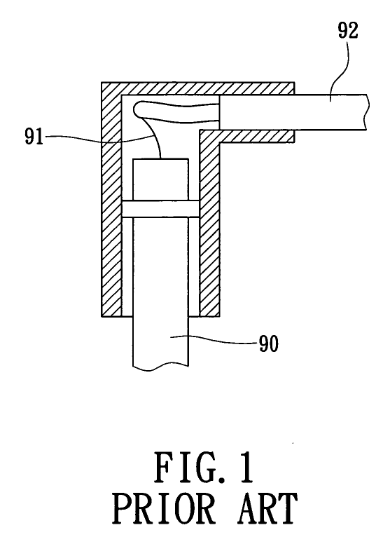

### DETAILED DESCRIPTION OF THE EMBODIMENTS

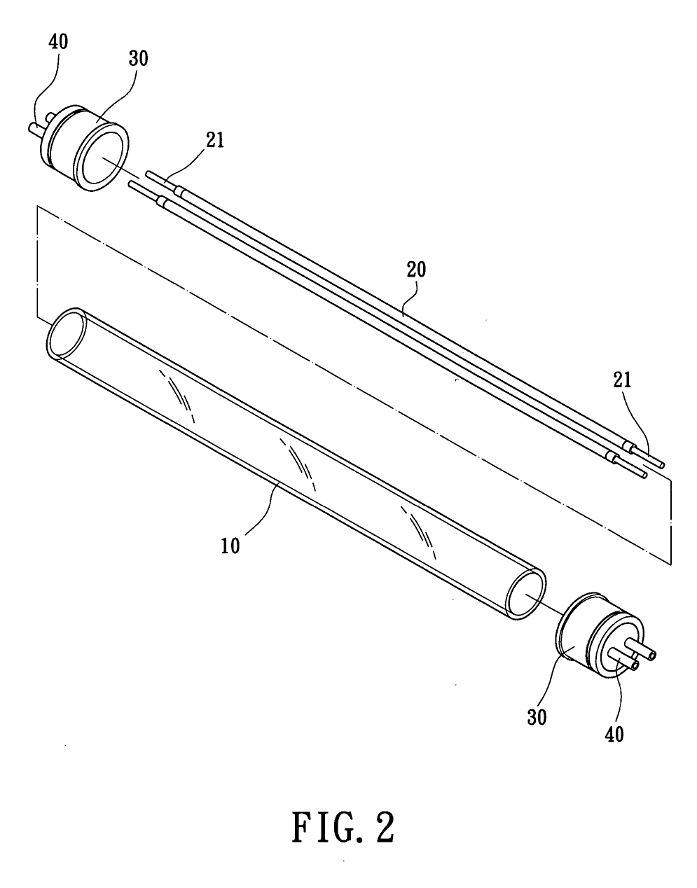

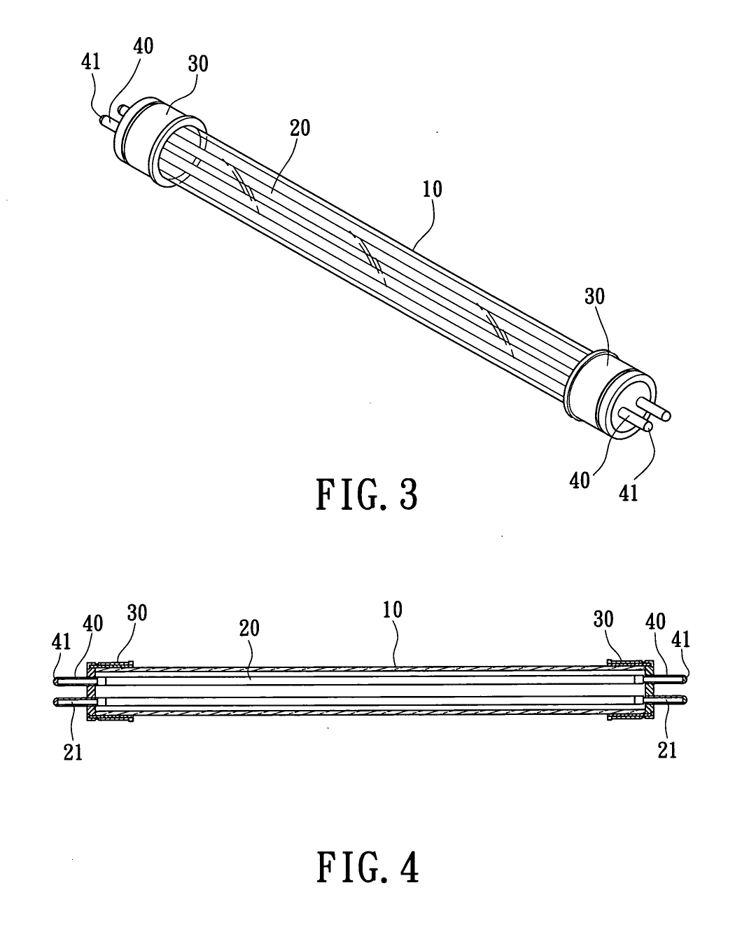

With respect to FIGS. 2 to 4, the present invention provides a CCFL tube device including a tube 10 made of transparent material, such as glass or the like, at least one CCFL 20 disposed in the tube 10 and having a lamp 21 exposed out of two ends thereof, a cap 30 covering each ends of the tube 10, and two terminals 40 symmetrically arranged in the cap 30 for electrically connecting the lamp 21. The tube 10 can be cylindrical and has two openings formed in two ends thereof. The tube 10 has various diameters and lengths for adoption to the quantity of the CCFL 20.

The CCFL 20, a cold cathode fluorescent lamp, can be selected to meet requirements. The lamp 21 of the CCFL 20 can extend out of two ends of the tube 10, and for the tube 10 enclosing the CCFL 20. The CCFL 20 can be protected to avoid damages.

The cap 30 is glued to cover the tube 10 for firm connection. The terminals 40 are made of metallic materials with high conductivity and penetrate through and secure to the cap 30. Each terminal 40 is a hollow pipe and the lamp 21 is exposed by the CCFL 20 to accommodate each of the terminals 40. Each terminal 40 is soldered to the lamp 21 following cutting tips of the terminals 40 for electrical connection between the lamp 21 and each of the terminals 40.

The present invention provides the CCFL tube device with the lamp 21 connecting to each of the terminals, and is adopted for a common fluorescent lamp. The present invention imitates a common fluorescent lamp with the tube 10 combining one or two CCFLs 20 arranged therein. Therefore, the CCFL tube device avoids the difficulties of orientations thereof and soldering problems and can replace a fluorescent lamp and be inserted into a socket originally intended for fluorescent lamp. Furthermore, the CCFL tube device can take advantages of reduced power consumption, long life, easy exchange, high production qualities, and high manufacture efficiency, as well as, more particularly, a high production quantity.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A CCFL tube device comprising:
a tube made of transparent materials;
a CCFL disposed in the tube and having a lamp exposed by two ends thereof;
a cap covering each end of the tube; and
two terminals symmetrically arranged in the cap for electrically connecting the lamp.

2. The CCFL tube device as claimed in claim 1, wherein the cap is glued to the tube for firm connection.

3. The CCFL tube device as claimed in claim 1, wherein the terminals penetrate through and secure to the cap, each terminal is a hollow pipe and the lamp is exposed by the CCFL to accommodate each of the terminals, and each terminal is soldered to the lamp following cutting tips of the terminals for electrical connection between the lamp and each of the terminals.
